(19) United States
(12) Patent Application Publication
(10) Pub. No.: US 2017/0272976 A1
(43) Pub. Date: Sep. 21, 2017

(54) LONG-RANGE LOW-POWER FRAME STRUCTURE

(71) Applicant: QUALCOMM Incorporated, San Diego, CA (US)

(72) Inventors: Lin YANG, San Diego, CA (US); Bin TIAN, San Diego, CA (US); Sameer VERMANI, San Diego, CA (US)

(21) Appl. No.: 15/457,429

(22) Filed: Mar. 13, 2017

Related U.S. Application Data
(60) Provisional application No. 62/308,832, filed on Mar. 15, 2016.

(51) Int. Cl. H04W 28/06

(52) U.S. Cl. CPC H04W 28/065

(57) ABSTRACT

The present application relates to transmitting data according to a frame structure. The described aspects include receiving data for transmission to at least one of an access point or a receiving station. The described aspects further include generating one or more first data packets according to one of a first frame structure including a first portion of one or more symbols associated with a first technology mode of a RAT and a second portion of one or more symbols associated with a second technology mode of the RAT or a second frame structure including one or more symbols associated with the second technology mode of the RAT. The described aspects further include transmitting the one or more packets.

### CROSS-REFERENCE TO RELATED APPLICATION(S)

This application claims the benefit of U.S. Provisional Application Ser. No. 62/308,832, entitled “LONG-RANGE LOW-POWER FRAME STRUCTURE” and filed on Mar. 15, 2016, which is expressly incorporated by reference herein in its entirety.

### BACKGROUND

The present disclosure relates generally to communication systems, and more particularly, to one or more frame structures in a long-range low-power communication network.

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

In accordance with an aspect, methods, apparatuses, and computer-readable media relate to transmitting data according to a frame structure. The described aspects include generating a data packet according to one of a first frame structure that includes a first portion of symbols associated with a first technology mode of a radio access technology (RAT) and a second portion of symbols associated with a second technology mode of the RAT or a second frame structure that includes one or more symbols associated with the second technology mode of the RAT. The described aspects further include transmitting the generated data packet.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a wireless communication system illustrating an example of a WLAN deployment in connection with various techniques described herein.

FIG. 2 is a diagram illustrating first and second variations of a first frame structure for supporting LRLP communications.

FIG. 3 is a diagram illustrating first and second variations of a second frame structure for supporting LRLP communications.

FIGS. 4A-B are diagrams illustrating an application of the variations of the first and second frame structures in different transmission modes (e.g., uplink or downlink).

FIG. 5 is a block diagram illustrating an aspect of a transmitting communication device in which systems and methods for communicating (e.g., transmitting data) in accordance with a determined transmission structure may be implemented and an aspect of a receiving communication device in which systems and methods for communicating (receiving data) in accordance with the determined transmission structure may be implemented.

FIGS. 6A-B illustrate resource units that a transmitting communication device may utilize for transmission.

FIG. 7 shows an example functional block diagram of a wireless device that performs LRLP communication within the wireless communication system of FIG. 1.

FIG. 8 is a flowchart of an example method of LRLP communications.

FIG. 9 is a functional block diagram of an example wireless communication device that may perform LRLP communications.

### DETAILED DESCRIPTION

Various aspects of the novel systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A STA may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a STA may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

In an aspect, MIMO schemes may be used for wide area WLAN (e.g., Wi-Fi) connectivity. MIMO exploits a radio-wave characteristic called multipath. In multipath, transmitted data may bounce off objects (e.g., walls, doors, furniture), reaching the receiving antenna multiple times through different routes and at different times. A WLAN device that employs MIMO will split a data stream into multiple parts, called spatial streams, and transmit each spatial stream through separate antennas to corresponding antennas on a receiving WLAN device.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

An aspect of the present disclosure generally relates to a communication structure which utilizes a portion of a wideband frequency spectrum to create a narrowband communication channel for long-range low-power (LRLP) communication. Specifically, in some communication networks, data transmission among or by stations may use high bandwidth channels for high data rate communication over short distances (e.g., 10 meters). However, a subset of stations may need to communicate over longer distances (e.g., one kilometer). In an aspect, a reduced portion of the bandwidth (e.g., 2 MHz) may be utilized to communicate over long distances. That is, stations such as Internet-of-Things (IoT) devices, smart grid devices, and/or building energy management systems may communicate at a lower data rate and higher/longer ranges. IoT devices may be used to support a variety of cases including sensor networks, industry, agriculture, security, smart homes, and smart/wearable devices. Further, such devices may also operate at lower power levels and/or have lower power supply level compared to stations communicating at higher data rates using a higher bandwidth channel (e.g., 20 MHz). As such, for LRLP communications, using high bandwidth channels for data transmissions may be inefficient from a power and bandwidth usage standpoint.

In an aspect, the present methods and apparatuses provide an efficient solution by enabling communication at lower frequencies, while increasing the communication range, by using a frame structure for communicating within or using a narrow band communication channel. That is, for device-to-device (D2D) type communications, it may be beneficial to extend the range from a number of meters to kilometers while reducing battery consumption. This may be done by reducing the data rate and the bandwidth such that the reduced data rate and bandwidth decrease transmission and reception power requirements. The range extension may result from the reduced bandwidth (e.g., 20 MHz to 2 MHz), which may provide for 10 dB of gain for example. An additional 3 dB of power gain may be achieved via down clocking and repetition. More than 13 dB of power gain may require longer preambles.

In another aspect, the frame structure may depend on the LRLP transmission mode and a desired target gain (e.g., to achieve longer range). The transmission mode may be uplink/downlink, single-user/multi-user, narrowband/wideband, synchronized/unsynchronized, triggered/spontaneous, etc. As such, the frame structure may be selected or determined based on the transmission mode and/or a target gain needed for LRLP devices.

As further described below, the methods and apparatuses disclosed herein may generate, configure, or map data received at a constellation and/or space-time-frequency mapper according to a frame and/or transmission structure having at least a bandwidth and subcarrier spacing based on a technology mode (e.g., an LRLP transmission mode) of a RAT. The frame structure, for example, may be backwards compatible with the frame structure of an existing framework (e.g., wideband communication channel) of a RAT such as wireless local area network, which enables backward compatibility and coexistence with the existing technology.

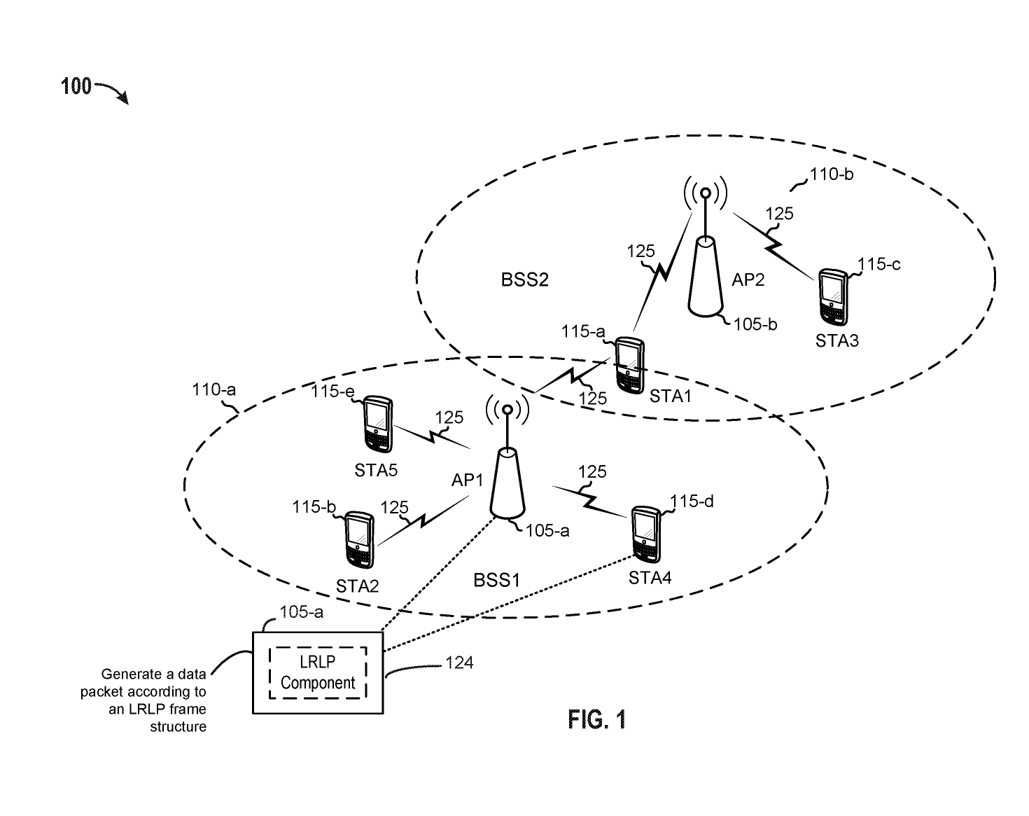

FIG. 1 is a wireless communication system 100 illustrating an example of a WLAN deployment in connection with various techniques described herein. The WLAN deployment may include one or more access points (APs) and one or more stations (STAs) associated with a respective AP. In this example, there may be two APs deployed for illustrative purposes: AP1 105-a in basic service set 1 (BSS1) and AP2 105-b in BSS2. AP1 105-a is shown having associated STAs (STA1 115-a, STA2 115-b, STA4 115-d, and STA5 115-e) and coverage area 110-a (or basic service area A), while AP2 105-b is shown having associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of the coverage areas. The number of BSSs, APs, and STAs, and the coverage areas of the APs described in connection with the WLAN deployment of FIG. 1 are provided by way of illustration and not of limitation. Moreover, aspects of the various techniques described herein are at least partially based on the example WLAN deployment of FIG. 1 but need not be so limited.

A variety of processes and methods may be used for transmissions in the wireless communication system 100 between the AP 105-a, for example, and the STAs. In one example, signals may be sent and received between the AP 105-a and the STAs in accordance with OFDM/orthogonal frequency-division multiple access (OFDMA) techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

The APs (e.g., AP1 105-a and AP2 105-b) shown in FIG. 1 are generally fixed terminals that provide backhaul services to STAs within its coverage area or region. In some applications, however, the AP may be a mobile or non-fixed terminal. The STAs (e.g., STA1 115-a, STA2 115-b, STA3 115-c, STA4 115-d, and STA5 115-e) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the IoT, or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, a small cell, or any other suitable terminology. The various concepts described throughout this disclosure are intended to apply to all suitable wireless apparatus regardless of their specific nomenclature.

Each of STA1 115-a, STA2 115-b, STA3 115-c, STA4 115-d, and STA5 115-e may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers or desirable for establishing or supporting a connection to a network.

Each of AP1 105-a and AP2 105-b can include software applications and/or circuitry to enable associated STAs to connect to a network via communications links 125. The APs can send frames to their respective STAs and receive frames from their respective STAs to communicate data and/or control information (e.g., signaling).

Each of AP1 105-a and AP2 105-b can establish a communications link 125 with an STA that is within the coverage area of the AP. Communications links 125 can comprise communications channels that can enable both uplink and downlink communications. When connecting to an AP, an STA can first authenticate itself with the AP and then associate itself with the AP. Once associated, a communications link 125 can be established between the AP and the STA such that the AP and the associated STA can exchange frames or messages through a communications channel.

In an aspect, the AP 105-a may transmit on one or more channels (e.g., multiple narrowband channels, each channel including a frequency bandwidth) a beacon signal (or simply a “beacon”), via a communication link such as the downlink, to other nodes (STAs) of the wireless communication system 100, which may help the other nodes (STAs) to synchronize their timing with the AP 105-a, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 115-b) may be required to associate with the AP 105-a in order to send communications to and/or to receive communications from the AP 105-a. In one aspect, information for associating is included in a beacon broadcast by the AP 105-a. To receive such a beacon, the STA 115-b may, for example, perform a broad coverage search over a coverage region. A search may also be performed by the STA 115-b by sweeping a coverage region in a lighthouse fashion, for example. After receiving the information for associating, the STA 115-b may transmit a reference signal, such as an association probe or request, to the AP 105-a. In some aspects, the AP 105-a may use backhaul services, for example, to communicate with a larger network, such as the Internet or a public switched telephone network (PSTN).

In another aspect, the AP 105-a may include one or more components for performing various functions. For example, the AP 105-a may include an LRLP component 124 configured generate a data packet according to one of a first frame structure comprising a first portion of symbols associated with a first technology mode of a RAT and a second portion of symbols associated with a second technology mode of the RAT or a second frame structure comprising one or more symbols associated with the second technology mode of the RAT. The LRLP component 124 may be configured to transmit the generated data packet.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in WANs, WLANs, PANs, or other suitable networks now known or later developed. Thus, the various aspects presented throughout this disclosure for determining a transmission structure including a bandwidth and subcarrier spacing and communicating in accordance with the foregoing determination may be applicable to any suitable wireless network regardless of the coverage range and the wireless access protocols utilized.

In an aspect, a STA such as STA1 115-a may utilize a narrow band transmission structure within a wideband channel for communicating with one or both of AP1 105-a or another STA such as STA2 115-b. Upon such a determination, STA1 115-a may communicate in a low-power long-range mode in accordance with the transmission structure including at least a determined bandwidth and subcarrier spacing.

In another aspect, a wireless device (e.g., the STA1 115-d or the AP1 105-a) may include one or more components for performing various functions. For example, the AP1 105-a may include an LRLP component 124 to perform procedures related to performing LRLP communications. In this example, the LRLP component 124 may be configured to generate a data packet according to one of a first frame structure that may include a first portion of symbols associated with a first technology mode of a RAT and a second portion of symbols associated with a second technology mode of the RAT or a second frame structure that may include one or more symbols associated with the second technology mode of the RAT. The LRLP component 124 may be configured to transmit the generated data packet.

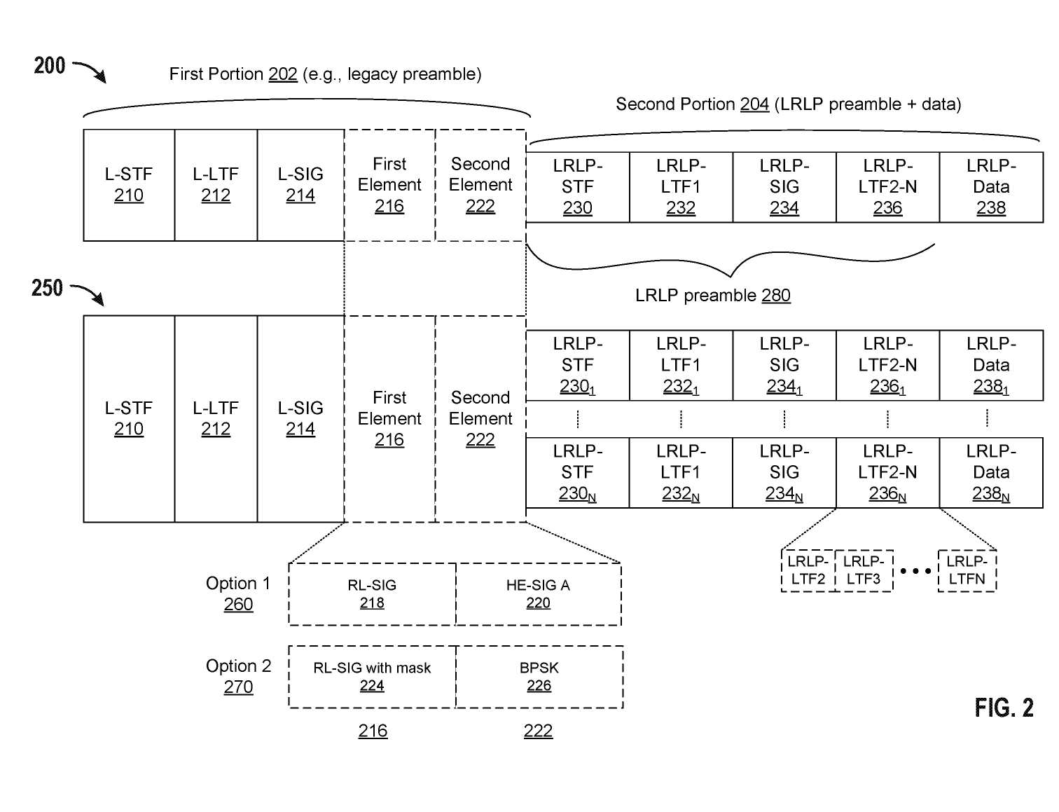

FIG. 2 is a diagram illustrating first and second variations 200, 250 of a first frame structure for supporting LRLP communications. Each of the first variation 200 and the second variation 250 may include a first portion 202 and a second portion 204. The first variation 200 may include one instance of the second portion 204, whereas the second variation 250 may include N instances of the second portion 204, where N is an integer greater than 1. The first variation 200 provides a mixed mode structure for SU transmission. The second variation 250 provides a mixed mode structure for MU transmission via frequency division multiple access (FDMA) or orthogonal frequency-division multiple access (OFDMA). The second variation 250 may include multiple instances of the second portion 204, and each instance of the second portion 204 may be provided to or transmitted by a different user and/or correspond to a different bandwidth or frequency.

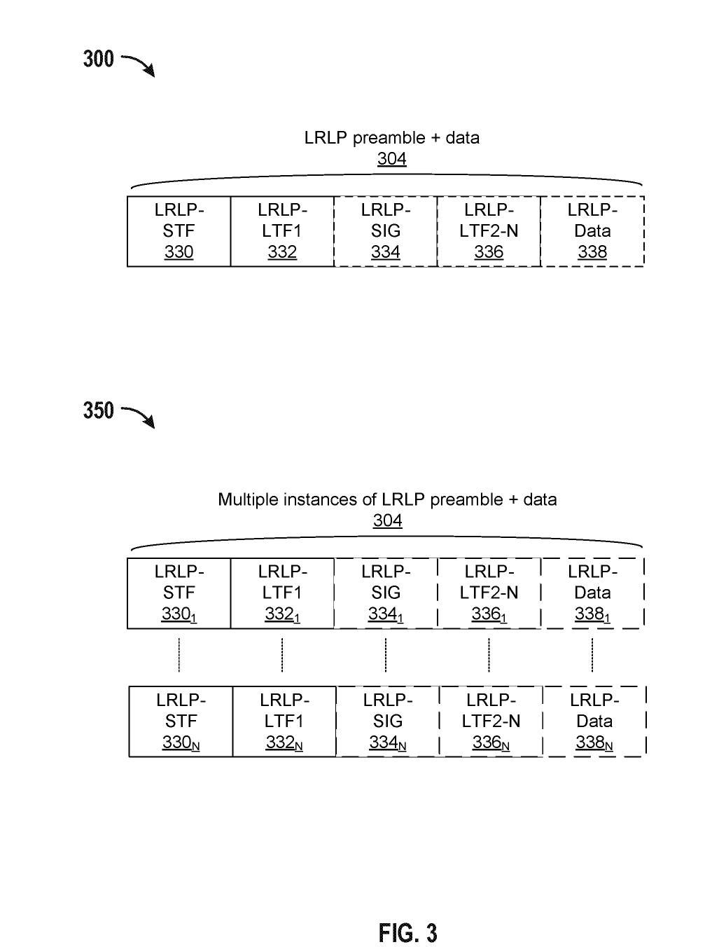

Referring to FIG. 2, the first portion 202 may include a legacy preamble, and the second portion 204 may include an LRLP preamble 280 and data (e.g., LRLP data 238). In some aspects, the legacy preamble may be associated with a first technology mode of a RAT. In some aspects, the first technology mode of the RAT may be compatible with one of an IEEE 802.11a, IEEE 802.11ac, IEEE 802.11n, IEEE 802.11ax, or another IEEE 802.11x standard. In some aspects, the LRLP preamble and data may be associated with a second technology mode of the RAT. In some aspects, the second technology mode of the RAT may correspond to an LRLP mode (e.g., devices with LRLP capability). When a device operates in the first technology mode, the device may include a legacy preamble in the first frame structure enables devices to avoid packet collisions because other devices that receive packets having the first frame structure may be able to decode the length or duration information associated with the received packet, and therefore, not transmit over the received packet. Devices may operate in the first technology mode when there are LRLP capable and non-LRLP capable devices within the vicinity. By contrast, the device may operate in the second technology mode when the device determines that all other devices within its vicinity are LRLP capable. An LRLP capable device is a device that may decode the LRLP packet as shown in FIG. 3 below.

In one configuration, the first portion 202 may include a legacy short training field (L-STF) 210 (e.g., of one or more symbol lengths), a legacy long training field (L-LTF) 212 (e.g., of one or more symbol lengths), a legacy signal (L-SIG) field 214 (e.g., of one or more symbol lengths), a first element 216, and a second element 222. In a first option 260, the first element 216 may correspond to a repeated legacy signal (RL-SIG) field 218 (e.g., of one or more symbol lengths), and the second element 222 may correspond to a high efficiency signal (HE-SIG) A field 220 (e.g., of two or more symbol lengths). In some aspects, the HE-SIG A field 220 may correspond to one of a high efficiency single user (HE-SU) signal field or a high efficiency extended mode single user (HE-EXT-SU) signal field. The HE-SU signal field and the HE-EXT-SU signal field may each carry 1 bit indicating that the second portion 204, having LRLP preamble and data, follows the first portion 202 (e.g., for LRLP packet indication). In an aspect, the HE-SIG A field 220 may have other information. For example, the HE-SIG A field 220 may have basic service set identifier (BSSID) information and transmit opportunity (TXOP) information. The TXOP information may indicate the whole packet length (e.g., from the beginning to the end of the packet). In a second option 270, the first element 216 may include an RL-SIG field 224 (e.g., having one or more symbols in length), and the RL-SIG field 224 may be processed with a mask such that the RL-SIG field 224 comprises a second technology mode indication. To process with the mask, the contents intended for the RL-SIG field 224 may be multiplied by a known sequence in the frequency domain, and the results may be mapped to symbols on a constellation. Only receivers that know the sequence will be able to decode the RL-SIG field 224 and determine that the second portion 204 follows the first portion 202. In the second option, the second element 222 may include a Binary Phase Shift Keying (BPSK) field (e.g., one or more symbols in length). In an aspect, the mask on the RL-SIG field 224 indicates that second portion 204 follows the first portion 202 and that the second portion 204 includes LRLP preamble and data.

The transmission of legacy preambles in the first portion 202 with LRLP preambles and data in the second portion 204 enables coexistence with legacy devices. That is, legacy devices may receive the first and second variations 200, 250 of the first frame structure and be able to decode the first portion 202. Referring to FIG. 2, the LRLP preamble and data may include an LRLP-STF 230, an LRLP-LTF1 232, an LRLP-SIG 234, a LRLP-LTF2-N 236, and an LRLP-Data 238. In an aspect, the LRLP-LTF2-N 236 may include multiple LTF symbols such as LRLP-LTF2, LRLP-LTF3, LRLP-LTF4, . . . , LRLP-LTFN for a total of N−1 symbols. In another aspect, the LRLP-LTF1 232 may include a basic service set (BSS) specific sequence, which identifies the BSS. For example, the BSS specific sequence may be a BSS identifier determined during device association. Because the BSS specific sequence is known, the BSS specific sequence in the LRLP-LTF1 232 may be used to aid timing and frequency estimation. In another aspect, the LRLP preamble length may be configurable based on one or both of a target gain or an LRLP transmission structure. Further, as illustrated in FIG. 2, the legacy preamble may precede the LRLP preamble and data.

In an aspect, the first portion 202 may have at least a 20 MHz bandwidth. In another aspect, the second portion 204 may have a lesser bandwidth than the first portion 202. For example, the second portion 204 may have a 2 MHz or 4 MHz bandwidth. In another aspect, the first portion 202 may not carry control information intended for a narrowband only receiver because the first portion 202 may occupy at least 20 MHz, and therefore, may not be decodable by a narrow band only LRLP receiver. In another aspect, with respect to the second portion 204, the frequency location of one or more instances of the second portion 204 may be pre-determined or negotiated before transmission. As such, the second portion 204 may have a different numerology (e.g., tone spacing, symbol duration, and/or CP length) than the first portion 202.

FIG. 3 is a diagram illustrating first and second variations 300, 350 of a second frame structure for supporting LRLP communications. Referring to FIG. 3, the first variation 300 of the second frame structure may include an LRLP preamble and data 304. In some aspects, the LRLP preamble and data 304 may be used for transmitting packets when a device is operating in an LRLP mode (the second technology mode). In such aspect, LRLP preamble and data 304 may be configurable according to a packet type. Specifically, for instance, the LRLP preamble and data 304 may be configurable based on one or both of a target gain or a transmission structure.

In an aspect, both the first and second variation 300, 350 may be known as a greenfield packet because the variations only have the LRLP preamble and data 304 and do not have a legacy preamble.

In one configuration, the LRLP preamble and data 304 may have an unsynchronized single user packet. An unsynchronized packet may be a packet that is not transmitted in response to a trigger or according to a schedule. The unsynchronized SU packet may include a second technology mode short training field (STF) 330, a second technology mode first long training field (LTF) 332, a second technology mode signal (SIG) field 334, a second technology mode second LTF 336, and LRLP data field 338. In some aspects, the second technology mode first LTF 332 may include a BSS-specific sequence that identifies the BSS.

In another configuration, the LRLP preamble and data 304 may correspond to a trigger-based second technology mode packet. The packet may include a shortened second technology mode STF 330, a second technology mode first LTF 332 having a BSS-specific sequence (enabling timing and frequency estimation), an optional second technology mode SIG field 334, a second technology mode second LTF 336, and a LRLP data field 338. In an aspect, the second technology mode first LTF 32 may be combined into the second technology mode second LTF 336. In this configuration, transmission of the packet may be triggered by a trigger frame, for example, and the trigger frame may indicate the resource allocation for transmitting the LRLP preamble and data 304. In an aspect, because the packet is triggered and therefore expected, the shortened second technology mode STF 330 may be used, and the shortened second technology mode STF 330 may have 4 symbols instead of 10 symbols. Because the packet is expected, the shortened second technology mode STF 330 need not be used for packet detection or timing estimation.

In another configuration, the LRLP preamble and data 304 may correspond to a synchronization packet (e.g., a beacon or a null data packet that enables device synchronization). In this configuration, the LRLP preamble and data 304 may include a shortened second technology mode STF 330 and one of a second technology mode first LTF 332 or a BSS specific sequence in its place. In this configuration, the packet may include an LRLP SIG field 334 and an LRLP data field 338. A shortened second technology mode STF may be used because timing estimation and packet detection are not necessary as resource allocation has already been determined.

In another configuration, the LRLP preamble and data 304 may correspond to a packet transmitted between time synchronized devices. In this configuration, the LRLP preamble and data 304 may include a shortened second technology mode STF 330, a second technology mode first LTF 332 corresponding to a BSS specific sequence, a second technology mode SIG 334, a second technology mode second LTF 336, and a LRLP data field 338. In this configuration, the packet may be transmitted on certain predetermined time slots (e.g., multiple time slots, each having a 4 μs durations may be used).

In an aspect, when communication is performed according to FDMA or OFDMA for MU transmissions, the LRLP preamble and data may be transmitted according to a second variation 350 of the second frame structure. Specifically, in FDMA or OFDMA, the LRLP preamble and data 304 may include an LRLP-STF 330_{N}, an LRLP-LTF1 332_{N}, an LRLP-SIG 334_{N}, a LRLP-LTF2 336_{N}, and an LRLP data field 638_{N}, where N is an integer greater than 1. In other words, the packet may include N instances of the LRLP preamble and data 304. Each instance of the LRLP preamble and data 304 may be associated with a distinct frequency range.

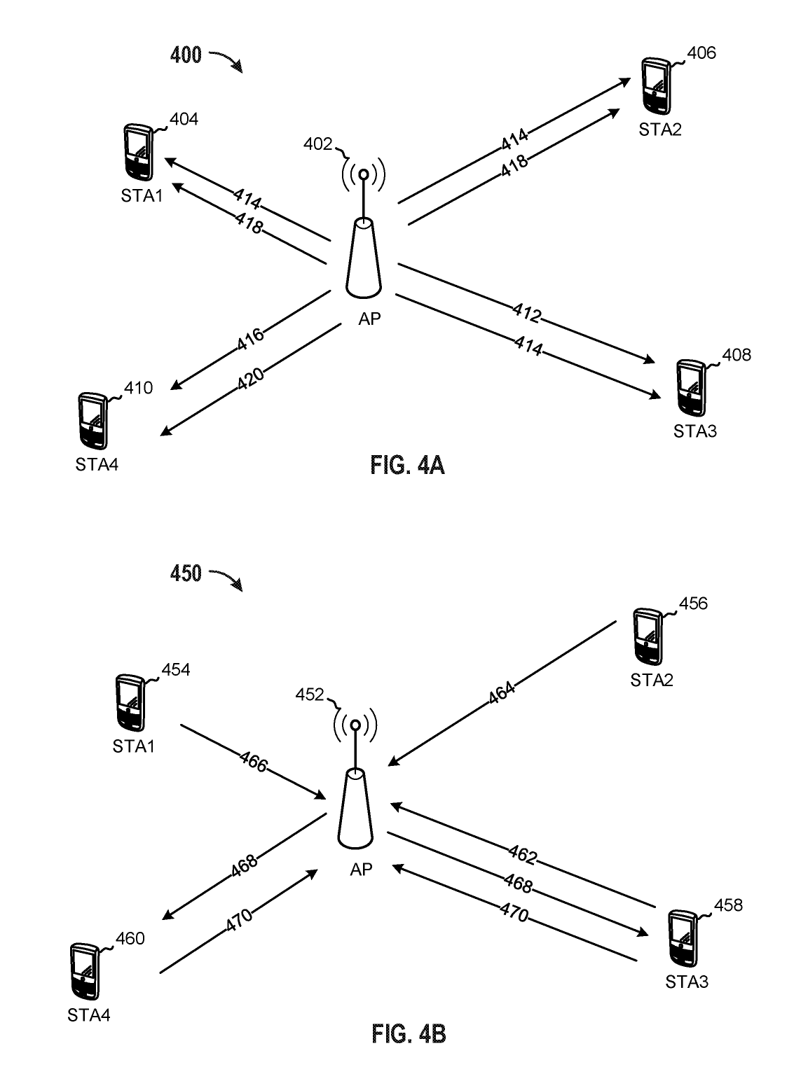

FIGS. 4A-B are diagrams 400, 450 illustrating an application of the variations of the first and second frame structures in different transmission modes (e.g., uplink or downlink). Referring to FIG. 4A, an AP 402 may be associated with STAs 404, 406, 408, 410. In FIG. 4A, different scenarios of downlink operation are described. In one configuration, a downlink transmission for a single user transmission is provided. In this configuration, the STA 408 may be LRLP capable but the STAs 404, 406, 410 may not be LRLP capable. When the AP 402 has an LRLP transmission for the STA 408 (e.g., an SU transmission in the downlink transmission mode), the AP 402 may transmit a first message 412 to the STA 408. The first message 412 may be the first variation 200 of the first frame structure when one or more of the other STAs 404, 406, 410 associated with the AP 402 are not LRLP capable. In this configuration, by using the first variation 200 of the first frame structure, the other STAs 404, 406, 410 may decode the legacy preamble, determine the length of the first message 412, set the network allocation vector (NAV) based on the length of the first message 412, and not transmit based on the set NAV.

In another configuration, a downlink transmission for a multi-user transmission is provided. In this configuration, the STAs 404, 406, 408 may be LRLP capable but the STA 410 may not be LRLP capable. When the AP 402 has an MU LRLP transmission for STAs 404, 406, 408 (e.g., an MU transmission in the downlink transmission mode), the AP 402 may transmit a second message 414 to the STAs 404, 406, 408. The second message 414 may be the second variation 250 of the first frame structure. In this configuration, by using the second variation 250 of the first frame structure, the STA 410 may decode the legacy preamble, determine the length of the second message 414, set the NAV based on the length of the second message 414, and not transmit based on the set NAV.

In another configuration, a downlink transmission in greenfield is provided. As shown in FIG. 3, during greenfield operation (or LRLP mode), the second frame structure is utilized, and the second frame structure lacks the legacy preamble. The AP 402 may determine to engage in greenfield operation when it determines that all of the STAs within the vicinity are LRLP capable. In this case, the STAs 404, 406, 408, 410 may all be LRLP capable. For SU transmission, the AP 402 may send a third message 416 to the STA 410, for example. The third message 416 may be an SU packet and may be the first variation 300 of the second frame structure. For MU transmission, the AP 402 may send a fourth message 418 to the STAs 404, 406, for example. The fourth message 418 may be an MU packet and may be the second variation 350 of the second frame structure.

In another configuration, a downlink transmission in which packets are transmitted under synchronization are provided. For example, the AP 402 and the STAs 404, 406, 408, 410 may be time synchronized, and the AP 402 may transmit a packet to the STAs 404, 406, 408, 410 at predetermined time slots. Referring to FIG. 4A, the AP 402 may send a fifth message 420 to the STA 410. The fifth message 420 may be of the first variation 300 of the second frame structure, and the fifth message 420 may have a shortened LRLP STF.

Referring to FIG. 4B, an AP 452 may be associated with STAs 454, 456, 458, 460. In FIG. 4B, different scenarios of uplink operation are described. In one configuration, an uplink transmission for a single user transmission is provided. In this configuration, the STA 458 may be LRLP capable but the STAs 454, 456, 460 may not be LRLP capable. When the STA 458 has an LRLP transmission for the AP 452 (e.g., an SU transmission in the uplink transmission mode), the STA 458 may transmit a sixth message 462 to the AP 452. In wideband operation, the sixth message 462 may be the first variation 200 of the first frame structure when one or more of the other STAs 454, 456, 460 are not LRLP capable. In narrowband operation, the sixth message 462 may be the first variation 200 of the first frame structure but without first portion (e.g., the legacy preamble). A separate wideband transmission may be used to transmit the first portion before the sixth message 462 is transmitted in order to protect the sixth message 462. When using the first variation 200 of the first frame structure, the other STAs 454, 456, 460 may decode the legacy preamble, determine the length of the sixth message 462, set the NAV based on the length of the sixth message 462, and not transmit based on the set NAV.

In another configuration, an uplink transmission in greenfield is provided. As shown in FIG. 3, during greenfield operation, the second frame structure is utilized, and the second frame structure lacks the legacy preamble. The AP 452 may determine to allow the STAs within the vicinity to engage in greenfield operation when it determines that all of the STAs within the vicinity of the AP 452 are LRLP capable. In this case, the STAs 454, 456, 458, 460 may all be LRLP capable, and the AP 452 may transmit an indication to the STAs 454, 456, 458, 460 that greenfield operation is permitted. For SU transmission, the STA 456 may send a seventh message 464 to the AP 452. The seventh message 464 may be an SU packet and may be the first variation 300 of the second frame structure. In an aspect, the seventh message 464 may have a shortened LRLP STF.

In another configuration, an uplink transmission in which packets are transmitted under synchronization are provided. For example, the AP 452 and the STAs 454, 456, 458, 460 may be time synchronized, and the STA 454 may transmit an eighth message 466 to the AP 452 at predetermined time slots. The eighth message 466 may be of the first variation 300 of the second frame structure, and the eighth message 466 may have a shortened LRLP STF.

In another configuration, an uplink transmission in which packets are trigger-based are provided. In this configuration, MU operation using OFDMA or FDMA may be supported. For example, the AP 452 may transmit a trigger message 468 to the STAs 458, 460. The trigger message 468 may identify the STAs 458, 460 and may indicate uplink resources (e.g., frequency resources) to use for uplink FDMA or OFDMA transmission. After receiving the trigger message 468, the STAs 458, 460 may transmit a ninth message 470 to the AP 452. The ninth message 470 may be transmitted using resources identified in the trigger message 468, and the ninth message 470 may be the second variation 350 of the second frame structure. The ninth message 470 may have a shortened LRLP STF and may optionally include an LRLP SIG field.

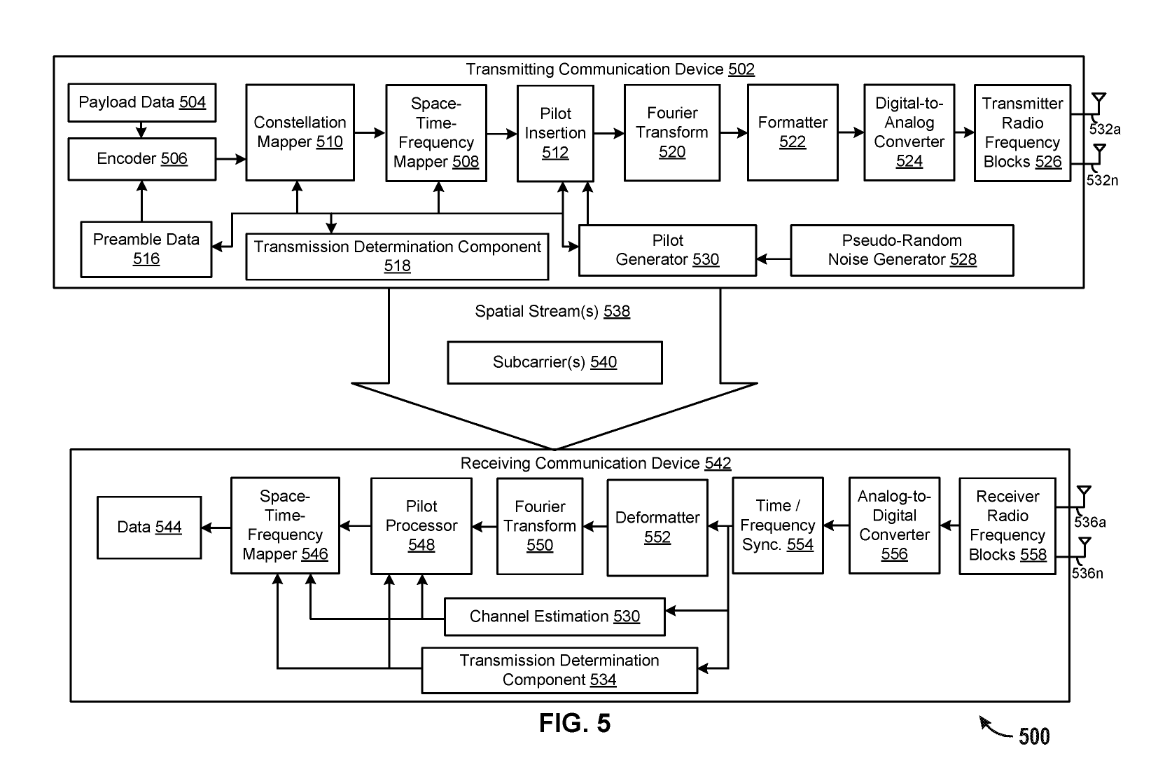

FIG. 5 is a block diagram illustrating an aspect of a transmitting communication device 502 in which systems and methods for communicating (e.g., transmitting data) in accordance with a determined transmission structure may be implemented and an aspect of a receiving communication device 542 in which systems and methods for communicating (receiving data) in accordance with the determined transmission structure may be implemented. In some aspects, the transmitting communication device 502 and/or the receiving communication device 542 may be any of the STAs 115 or APs 105 of FIG. 1. That is, in some aspects, any of the STAs 115 or the APs 105 of FIG. 1 may include some or all of the components and/or functionalities of the transmitting communication device 502 and/or the receiving communication device 542.

The transmitting communication device 502 may include an encoder 506 with an input for receiving payload data 504 and/or preamble data 516 to be transmitted to one or more receiving communication devices 542. The payload data 504 may include voice, video, audio and/or other data. The preamble data 516 may include control information, such as information that specifies a data rate, modulation and coding scheme (MCS), channel bandwidth, etc. The encoder 506 may encode the payload data 504 and the preamble data 516 for forward error correction (FEC), encryption, packeting, and/or other encodings for use with wireless transmission.

A constellation mapper 510 maps the data provided by the encoder 506 into modulation symbols. For instance, the constellation mapper 510 may use modulation schemes such as binary phase-shift keying (BPSK), quadrature amplitude modulation (QAM), etc. Where QAM is used, for example, the constellation mapper 510 may provide two bits per spatial stream 538, per data subcarrier 540, per symbol period. Furthermore, the constellation mapper 510 may output a 16-QAM constellation signal for each spatial stream 538 for each data subcarrier 540 for each symbol period. Other modulations may be used, such as 64-QAM, which would result in a consumption of six bits per spatial stream 538, per data subcarrier 540, per symbol period. Other variations are also possible.

The output of the constellation mapper 510 may be provided to a space-time-frequency mapper 508 that maps the data onto Spatial-Time-Frequency dimensions of the transmitter. The dimensions represent various constructs or resources that allow for data to be allocated. A given bit or set of bits (e.g., a grouping of bits, a set of bits that correspond to a constellation point, etc.) may be mapped to a particular place among the dimensions. In general, bits and/or signals mapped to different places among the dimensions are transmitted from the transmitting communication device 502 such that they are expected to be, with some probability, differentiable at one or more receiving communication devices 542. In some aspects, the space-time-frequency mapper 508 may perform space-time block coding (STBC).

One or more spatial streams 538 may be transmitted from the transmitting communication device 502 such that the transmissions on different spatial streams 538 may be differentiable at a receiver. For example, bits mapped to one spatial dimension are transmitted as one spatial stream 538. That spatial stream 538 may be transmitted on antenna 532 spatially separate from other antennas 532, orthogonally super positioned over a plurality of spatially-separated antennas 532, and a corresponding polarization, etc. Many techniques for spatial stream 538 separation (involving separating antennas 532 in space or other techniques that would allow their signals to be distinguished at a receiver, for example) may be used.

In the example shown in FIG. 5, there are one or more spatial streams 538 that are transmitted using the same or a different number of antennas 532 a-n (e.g., one or more). In some instances, only one spatial stream 538 may be available because of inactivation of one or more other spatial streams 538.

In the case that the transmitting communication device 502 uses a plurality of frequency subcarriers 540, there are multiple values for the frequency dimension, such that the space-time-frequency mapper 508 may map some bits to one frequency subcarrier 540 and other bits to another frequency subcarrier 540. Other frequency subcarriers 540 may be reserved as guard bands, pilot tone subcarriers, or the like that do not (or do not always) carry data. For example, the subcarriers 540 may include one or more data subcarriers and one or more pilot subcarriers. It should be noted that, in some instances or aspects, not all subcarriers 540 may be used at once. For instance, some tones may be used as guard tones to reduce interference and enable filtering. In some aspects, the transmitting communication device 502 may utilize OFDM for the transmission of multiple subcarriers 540. For instance, the space-time-frequency mapper 508 may map (encoded) data (e.g., payload data 504 and/or preamble data 516) to space, time, and/or frequency resources according to the multiplexing scheme or transmission structure used.

The time dimension refers to symbol periods. Different bits may be allocated to different symbol periods. Where there are multiple spatial streams 538, multiple subcarriers 540 and multiple symbol periods, the transmission for one symbol period may be referred to as an “OFDM (orthogonal frequency-division multiplexing) MIMO (multiple-input, multiple-output) symbol.” A transmission rate for encoded data may be determined by multiplying the number of bits per simple symbol (e.g., log₂ of the number of constellations used) times the number of spatial streams 538 times the number of data subcarriers 540, divided by the length of the symbol period.

Thus, the space-time-frequency mapper 508 may map bits (or other units of input data) to one or more spatial streams 538, data subcarriers 540 and/or symbol periods. Separate spatial streams 538 may be generated and/or transmitted using separate paths. In some implementations, these paths are implemented with distinct hardware, whereas in other implementations, the path hardware is reused for more than one spatial stream 538 or the path logic is implemented in software that executes for one or more spatial streams 538. More specifically, each of the elements illustrated in the transmitting communication device 502 may be implemented as a single block/module or as multiple blocks/modules. For instance, the transmitter radio frequency block(s) 526 element may be implemented as a single block/module or as multiple parallel blocks/modules corresponding to each antenna 532 a-n (e.g., each spatial stream 538). As used herein, the term “block/module” and variations thereof may indicate that a particular element or component may be implemented in hardware, software or a combination of both.

In some aspects, transmitting communication device 502 may utilize OFDMA. In OFDMA, an OFDM symbol is constructed of subcarriers, the number of which may be a function of the fast Fourier transform (FFT) size. For example, OFDMA employs multiple subcarriers, but the subcarriers are divided into several groups of subcarriers where each group is denoted a resource unit (RU). The grouping of subcarriers into groups of resource units is referred to as sub-channelization. In a high efficiency (HE) configuration, the subcarriers that form a RU may be physically adjacent (contiguous except at the middle of the band where nulls are placed at direct current (DC)). In one example, a 26-subcarrier RU may have of 24 data subcarriers and 2 pilot subcarriers.

The transmitting communication device 502 may include a pilot generator block/module 530. The pilot generator block/module 530 may generate a pilot sequence. A pilot sequence may be a group of pilot symbols. In some aspects, for instance, the values in the pilot sequence may be represented by a signal with a particular phase, amplitude and/or frequency. For example, a “1” may denote a pilot symbol with a particular phase and/or amplitude, while a “−1” may denote a pilot symbol with a different (e.g., opposite or inverse) phase and/or amplitude.

The transmitting communication device 502 may include a pseudo-random noise generator 528 in some aspects. The pseudo-random noise generator 528 may generate a pseudo-random noise sequence or signal (e.g., values) used to scramble the pilot sequence. For example, the pilot sequence for successive OFDM symbols may be multiplied by successive numbers from the pseudo-random noise sequence, thereby scrambling the pilot sequence per OFDM symbol. When the pilot sequence is sent to a receiving communication device 542, the received pilot sequence may be unscrambled by a pilot processor 548.

The output(s) of the space-time-frequency mapper 508 may be spread over frequency and/or spatial dimensions. A pilot insertion block/module 512 inserts pilot tones into the pilot tone subcarriers 540. For example, the pilot sequence may be mapped to subcarriers 540 at particular indices. For instance, pilot symbols from the pilot sequence may be mapped to subcarriers 540 that are interspersed with data subcarriers 540 and/or other subcarriers 540. In other words, the pilot sequence or signal may be combined with the data sequence or signal. In some aspects, one or more direct current (DC) tones may be centered at index 0.

Further, the transmitting communication device 502 may include a transmission determination component 518. The transmission determination component 518 may be configured to determine a transmission structure including at least a bandwidth and subcarrier spacing based on a technology mode of a RAT (e.g., WLAN) to be used for transmissions to one or more receiving communication devices 542. For example, the transmission determination component 518 may be configured to whether to use a first variation of the first frame structure, a second variation of the first frame structure, a first variation of the second frame structure, or a second variation of the second frame structure. In some aspects, the technology mode may be based on IEEE 802.11. For example, in order to provide for low power and long range communication between the transmitting communication device 502 and the receiving communication device 542, transmission determination component 518 may determine a transmission structure by which to facilitate such communication including one or more of a subcarrier spacing, a bandwidth, an FFT size, an OFDM/A symbol duration, a cyclic prefix (CP) length, an MCS mode, and/or a modulation type/rate. For instance, in an aspect, transmission determination component 518 may be configured to determine a transmission structure in accordance an existing with technology mode (e.g., high efficiency framework, 802.11ax, and/or 802.11ah), as outlined in Table 1-3 below.

TABLE 1
LRLP transmission structure in high-efficiency framework

| Target gain over | | |
|---|---|---|
| 802.11ax at 20 MHZ | 13 dB | 20 dB |
| Tone Spacing | 78.125 KHz | 78.125 KHz |
| Bandwidth (for data) | Resource Unit (RU) | Resource Unit (RU) |
| | 26 = 2 MHz | 26/2 = 1 MHz-Dual Carrier |
| | | Modulation mode |
| FFT Size | 32 (2.5 MHz bandwidth) | 32 (2.5 MHz bandwidth) |
| Symbol Duration | 12.8 μs + GI | 12.8 μs + GI |
| CP Length | 3.2/1.6/0.8 μs | 3.2/1.6/0.8 μs |
| Low MCS Mode | | |
| BPSK rate ½, 2x | 0.4412 Mbps (0.8 μs GI) | |
| Repetition | | |
| BPSK rate ½, 4x | | 0.0938 Mbps (3.2 μs GI) |
| Repetition | | |
| Effective Gain | 12 dB | 18 dB |

TABLE 2
LRLP transmission structure in 802.11ax technology mode

| Target gain over | | |
|---|---|---|
| 802.11ax at 20 MHZ | 20 dB | 20 dB |
| Tone Spacing | 78.125 KHz | 78.125 KHz |
| Bandwidth (for data) | RU13 = 1.0156 MHz | RU6 = 0.46875 MHz |
| | (1 pilot) | (1 pilot) |
| FFT Size | 16 (1.25 MHz bandwidth) | 8 (0.625 MHz bandwidth) |
| Symbol Duration | 12.8 μs + GI | 12.8 μs + GI |
| CP Length | 3.2/1.6/0.8 μs | 3.2/1.6/0.8 μs |
| Low MCS Mode | | |
| BPSK rate ½, 2x | 0.1875 Mbps (3.2 μs GI) | 0.0781 Mbps (3.2 μs GI) |
| Repetition | | |
| BPSK rate ½, 4x | 0.0938 Mbps (3.2 μs GI) | 0.03905 Mbps (3.2 μs GI) |
| Repetition | | |
| BPSK rate ½, 8x | 0.0469 Mbps (3.2 μs GI) | |
| Repetition | | |
| Effective Gain | 21 dB | 21 dB |

TABLE 3
LRLP transmission structure in 802.11ah technology mode

| Target gain over | | |
|---|---|---|
| 802.11ax at 20 MHZ | 13 dB | 20 dB |
| Tone Spacing | 31.25 KHz | 31.25 KHz |
| Bandwidth | 2 MHz | 1 MHz |
| FFT Size | 64 | 32 |
| Symbol Duration | 32 μs + GI | 32 μs + GI |
| CP Length | 8/4 μs | 8/4 μs |
| Low MCS Mode | | |
| BPSK rate ½, 2x | 0.325 Mbps | |
| Repetition | (8 μs GI) | |
| BPSK rate ½, 4x | | 0.075 Mbps (8 μs GI) |
| Repetition | | |
| Effective Gain | 13 dB | 19 dB |

In some aspects, transmission determination component 518 may be configured to communicate using a transmission structure giving an extended symbol duration. For example, in order to reduce the CP overhead, and to accommodate longer CP durations that provide more room for timing error and roundtrip delay, a transmission structure of 12.5 KHz tone spacing and Bus CP having a 80 us symbol duration and 10% overhead may be utilized. Additionally, in such aspect, greenfield transmission and coexistence/protection may be provided by the AP.

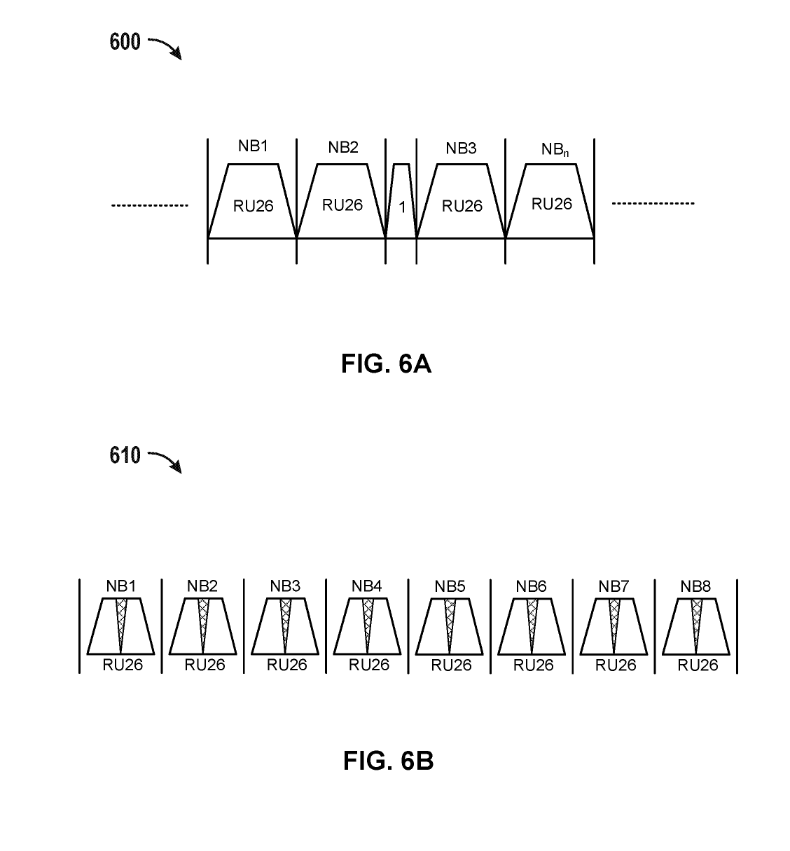

As part of configuring the received data, the transmission determination component 518 may provide an indication of the transmission structure to one or more components/blocks/modules. For example, in an aspect shown in FIG. 6A, one or more blocks/modules/components of transmitting communication device 502 such as, but not limited to one or both of the constellation mapper 510 and the space-time-frequency mapper 508 may configure the data for transmission by allocating 26 resource units per transmission of the data based on a determination that the transmission structure may include a 78.125 KHz subcarrier spacing and a 2 MHz data bandwidth. That is, each narrow band transmission of transmission structure 600 may occupy or be allocated one 26 resource unit block (also referred to as a 26 subcarrier resource unit). Each resource unit may have no DC tones and no guard tones in between.

Further, in an aspect shown in FIG. 6B, one or more blocks/modules/components of transmitting communication device 502 such as, but not limited to one or both of the constellation mapper 510 and the space-time-frequency mapper 508 may configure the data for transmission by allocating 26 resource units per transmission having a direct current subcarrier and at least two guard tones between the each transmission based on a determination that the transmission structure 310 includes a 78.125 KHz subcarrier spacing and a 2.5 MHz bandwidth corresponding to a Fast Fourier Transform size of 32. That is, each narrow band transmission of transmission structure 610 may be associated with a 2.5 MHz bandwidth and FFT size of 32, which provides for 26 resource units allocated for data along with a single DC or null subcarrier and 3/2 guard tones (e.g., 5 guard tones for the RU that includes zero frequency bin). For example, the transmission structure 610 reduces leakage between adjacent bands by providing 5 guard tones at the edges of the band with the center 26 tones carrying data. As such, the individual transmission DC or null subcarrier and the guard tones between the narrow band transmissions may protect from leakage or interference to neighboring bands.

In some aspects, one or more blocks/modules/components of transmitting communication device 502 such as, but not limited to one or both of the constellation mapper 510 and the space-time-frequency mapper 508 may configure the received data according to a transmission structure including a 78.125 KHz subcarrier spacing and one of a 1.0156 MHz bandwidth corresponding to a 13 resource unit transmission allocation for data or a 0.46875 MHz bandwidth corresponding to a 6 resource unit transmission allocation for data. For instance, the 1.0156 MHz bandwidth may be associated with a FFT size of 16 and the 0.46875 MHz bandwidth may be associated with a FFT size of 8.

Additionally, one or more blocks/modules/components of transmitting communication device 502 such as, but not limited to one or both of the constellation mapper 510 and the space-time-frequency mapper 508 may configure the received data according to a transmission structure including a 31.25 KHz subcarrier spacing and one of a 1 MHz bandwidth corresponding to a FFT size of 32 or a 2 MHz bandwidth corresponding to a FFT size of 64.

In addition, for instance, the indication may be provided to the constellation mapper 510, the space-time-frequency mapper 508, the pilot insertion block/module 512 and/or the pilot generator 530. Additionally or alternatively, the indication may be provided as part of preamble data 516. For instance, one or more bits in the preamble data 516 may be allocated to represent the indication of the transmission structure. Additionally or alternatively, the indication may be implicitly indicated in the preamble data 516. This indication of the transmission structure may thus be signaled to the one or more receiving communication devices 542. This may enable the one or more receiving communication devices 542 to receive preamble data 516 using the selected transmission structure.

For example, the space-time-frequency mapper 508 may use the indication of the transmission structure to map the preamble data 516 to a number of tones (e.g., subcarriers 540). For example, the systems and methods disclosed herein may define a number of OFDM tones or subcarriers 540 that may be used by the transmitting communication device 502 for the transmission of preamble data 516 based on the channel bandwidth (as specified by the indication, for example). The number of OFDM tones may also be specified according to a particular preamble field. For example, the space-time-frequency mapper 508 may map preamble data 516 to a number of OFDM tones based on the transmission structure determination and the preamble field as indicated in one of Tables 1-3 above. In some aspects, the space-time-frequency mapper 508 may use a look-up table to determine the number of tones or subcarriers to use for a specified bandwidth. In some aspects, the space-time-frequency mapper 508 and/or the constellation mapper 510 may be configured to map the received data to one or more subcarriers in accordance with a determination of the transmission structure.

In some aspects, the indication of the transmission structure may also be provided to the pilot generator 530. The pilot generator 530 may use the bandwidth indication to generate an appropriate number of pilot symbols.

In some aspects, the indication of the transmission structure may additionally be provided to the pilot insertion block/module 512. The pilot insertion block/module 512 may use this indication to determine subcarrier indices 514 for pilot symbol insertion.

The data and/or pilot signals are provided to an inverse discrete Fourier transform (IDFT) block/module 520. The inverse discrete Fourier transform (IDFT) block/module 520 converts the frequency domain signals of the payload data 504 and the preamble data 516 and inserted pilot tones into time domain signals representing the signal over the spatial streams 538 and/or time-domain samples for a symbol period. In an aspect, for example, the IDFT block/module 520 may perform a 256-point inverse fast Fourier transform (IFFT).

The time-domain signal is provided to a formatter 522. The formatter (e.g., one or more formatting blocks/modules) 522 may take the output of the inverse discrete Fourier transform (IDFT) block/module 520, convert it from parallel signals to serial (P/S), add a cyclical prefix and/or perform guard interval windowing.

The formatter 522 output may be provided to a digital-to-analog converter (DAC) 524. The digital-to-analog converter (DAC) 524 may convert the formatter 522 output from one or more digital signals to one or more analog signals. The digital-to-analog converter (DAC) 524 may provide the analog signal(s) to one or more transmitter radio-frequency (TX RF) blocks 526.

The one or more transmitter radio frequency blocks 526 may be coupled to or include a power amplifier. The power amplifier may amplify the analog signal(s) for transmission. The one or more transmitter radio frequency blocks 556 may output radio-frequency (RF) signals to one or more antennas 532 a-n, thereby transmitting the payload data 504 and the preamble data 516 that was input to the encoder 506 over a wireless medium suitably configured for receipt by one or more receiving communication devices 542.

One or more receiving communication devices 542 may receive and use signals from the transmitting communication device 502. For example, a receiving communication device 542 may use a received bandwidth indicator to receive a given number of OFDM tones or subcarriers 540. Additionally or alternatively, a receiving communication device 542 may use a pilot sequence generated by the transmitting communication device 502 to characterize the channel, transmitter impairments and/or receiver impairments and use that characterization to improve receipt of payload data 504 and preamble data 516 encoded in the transmissions.

For example, a receiving communication device 542 may include one or more antennas 536 a-n (which may be greater than, less than or equal to the number of transmitting communication device 502 antennas 532 a-n and/or the number of spatial streams 538) that feed to one or more receiver radio-frequency (RX RF) blocks 558. The one or more receiver radio-frequency (RX RF) blocks 558 may output analog signals to one or more analog-to-digital converters (ADCs) 556. For example, a receiver radio-frequency block 558 may receive and downconvert a signal, which may be provided to an analog-to-digital converter 556. As with the transmitting communication device 502, the number of spatial streams 538 processed may or may not be equal to the number of antennas 536 a-n. Furthermore, each spatial stream 538 need not be limited to one antenna 136, as various beam-steering, orthogonalization, etc. techniques may be used to arrive at a plurality of receiver streams.

The one or more analog-to-digital converters (ADCs) 556 may convert the received analog signal(s) to one or more digital signal(s). These output(s) of the one or more analog-to-digital converters (ADCs) 556 may be provided to one or more time and/or frequency synchronization blocks/modules 554. A time and/or frequency synchronization block/module 554 may (attempt to) synchronize or align the digital signal in time and/or frequency (to a receiving communication device 542 clock, for example).

The (synchronized) output of the time and/or frequency synchronization block(s)/module(s) 554 may be provided to one or more deformatters 552. For example, a deformatter 552 may receive an output of the time and/or frequency synchronization block(s)/module(s) 554, remove prefixes, etc. and/or parallelize the data for discrete Fourier transform (DFT) processing.

One or more deformatter 552 outputs may be provided to one or more discrete Fourier transform (DFT) blocks/modules 550. The discrete Fourier transform (DFT) blocks/modules 550 may convert one or more signals from the time domain to the frequency domain. A pilot processor 548 may use the frequency domain signals (per spatial stream 538, for example) to determine one or more pilot tones (over the spatial streams 538, frequency subcarriers 540 and/or groups of symbol periods, for example) sent by the transmitting communication device 502. The pilot processor 548 may additionally or alternatively de-scramble the pilot sequence. The pilot processor 548 may use the one or more pilot sequences described herein for phase and/or frequency and/or amplitude tracking. The pilot tone(s) may be provided to a space-time-frequency detection and/or decoding block/module 546, which may detect and/or decode the data over the various dimensions. The space-time-frequency detection and/or decoding block/module 546 may output received data 544 (e.g., the receiving communication device's 542 estimation of the payload data 504 and/or preamble data 516 transmitted by the transmitting communication device 502).

In some aspects, the receiving communication device 542 knows the transmit sequences sent as part of a total information sequence. The receiving communication device 542 may perform channel estimation with the aid of these known transmit sequences. To assist with pilot tone tracking, processing and/or data detection and decoding, a channel estimation block/module 560 may provide estimation signals to the pilot processor 548 and/or the space-time-frequency detection and/or decoding block/module 546 based on the output from the time and/or frequency synchronization block/module 554. Alternatively, if the de-formatting and discrete Fourier transform is the same for the known transmit sequences as for the payload data portion of the total information sequence, the estimation signals may be provided to the pilot processor 548 and/or the space-time-frequency detection and/or decoding block/module 546 based on the output from the discrete Fourier transform (DFT) blocks/modules 550.

The transmission determination component 534 may use the time/frequency synchronization block/module 554 output to receive the indication of the transmission structure (for received communications). For example, the transmission determination component 534 may receive the indication from the transmitting communication device 502 that indicates a transmission structure. For instance, the transmission determination component 534 may obtain an explicit or implicit indication. In an aspect, the indication of the transmission structure may indicate a channel bandwidth and/or a subcarrier spacing. Based on the indication the transmission determination component 534 may determine whether the received signal is of a first variation of the first frame structure, a second variation of the first frame structure, a first variation of the second frame structure, or a second variation of the second frame structure. The transmission determination component 534 may determine the transmission or communication structure for received communication based on the indication and provides an indication of the determined structure to the pilot processor 548 and/or to the space-time-frequency detection/decoding block/module 546.

For example, the pilot processor 548 may use the determined transmission structure to extract pilot symbols from the discrete Fourier transform block/module 550 output.

The space-time frequency detection/decoding block/module 546 may use the determined transmission structure to detect and/or decode preamble data and/or payload data from the received signal. In some aspects, the space-time-frequency detection/decoding block/module 546 may use a look-up table to determine the number of tones or subcarriers to receive for a specified bandwidth.

Further, one or both of transmission determination component 518 or transmission determination component 534 may be configured to determine a frame structure by which to generate one or more data packets, in the case of transmission determination component 518, and determine a frame structure by which received one or more data packets have been or otherwise were generated, in the case of transmission determination component 534. In some aspects, transmission determination component 518 and transmission determination component 534 may be configured to determine a frame structure for generation of data packets and subsequent determination of a frame structure for received data packets, respectively, based on or within the transmission structure (e.g., LRLP) described herein.

For example, one or both of transmission determination component 518 or transmission determination component 534 may be configured to support communication according a frame structure to support various transmission modes and target gains for LRLP devices that provides coexistence with legacy devices. For instance, one or both of transmission determination component 518 or transmission determination component 534 may be configured to determine a transmission mode (e.g., UL or DL; SU or MU, etc.) and a target gain (e.g., for range extension and reduced battery consumption) as shown in Table 4 below, and to determine a frame structure given the transmission mode and target gain for generation of data packets according to the determined frame structure.

TABLE 4
Application of frame structures to transmission mode and target gain

| | Target gain over 11ax | | |
|---|---|---|---|
| Transmission mode | 2 0MHz | 13 dB | 20 dB |
| DL | SU | 200 (FIG. 2) | 200 (FIG. 2) |
| | MU | 250 (FIG. 2) | 250 (FIG. 2) |
| | Greenfield SU/MU: | 300 or 350 (FIG. 3) | 300 or 350 (FIG. 3) |
| | legacy portion dropped | | (with shortened |
| | | | LRLP-STF if trigger- |
| | | | based) |
| | Sync mode operation | 300 or 350 (FIG. 3) | 300 or 350 (FIG. 3) |
| | | (with shortened | (with shortened |
| | | LRLP-STF) | LRLP-STF) |
| UL | SU (w/ WB Tx) | 200 (FIG. 2) | 200 (FIG. 2) |
| | SU (w/NB Tx): other | 200 (FIG. 2) (with | 200 (FIG. 2) (with |
| | WB Tx to transmit | only second portion) | only second portion) |
| | preamble portion S1 | | |
| | for protection | | |
| | Green Field SU: legacy | 300 (FIG. 3) | 300 (FIG. 3) (with |
| | portion dropped | | shortened LRLP-STF |
| | | | if trigger-based) |
| | Sync mode operation | 300 or 350 (FIG. 3) | 300 or 350 (FIG. 3) |
| | | (with shortened | (with shortened |
| | | LRLP-STF) | LRLP-STF) |
| | Trigger-based UL- | 350 (FIG. 3) (with | 350 (FIG. 3) (with |
| | OFDMA/FDMA (if | shortened LRLP-STF | shortened LRLP-STF |
| | LRLP STA supports | and LRLP-SIG is | and LRLP-SIG is |
| | WB Tx, then with WB | optional) | optional) |
| | trigger, the LRLP STA | | |
| | can transmit with 1 lax | | |
| | frame format) | | |

Specifically, transmission determination component 518 may be configured to receive, at a component of a transmitter chain (e.g., encoder), data for transmission to at least one of an access point (AP) or a receiving station (e.g., receiving communication device 542). Transmission determination component 518 may then be configured to generate one or more first data packets according to one of a first frame structure (e.g., mixed-mode structure as described herein with respect to FIGS. 2 and 3) including a first portion (e.g., legacy preamble portion) of one or more symbols associated with a first technology mode (e.g., 802.11a or 802.11ax) of a radio access technology (RAT) and a second portion (e.g., LRLP preamble and data) of one or more symbols associated with a second technology mode (e.g., LRLP) of the RAT or a second frame structure including one or more symbols associated with the second technology mode of the RAT. In some aspects, prior to generating the one or more packets, transmission determination component 518 may be configured to determine a frame structure based on a transmission mode (e.g., UL or DL; SU or MU, etc.) and a target gain (e.g., for range extension and reduced battery consumption) as shown in Table 4 above. Further, transmission determination component 518 may be configured to transmit, using one or more antennas 532a and/or 532n coupled to the transmitter chain, the one or more packets. In some aspects, transmitting the generated data packets includes transmitting via one of a downlink communication channel or an uplink communication channel. Further, receiving communication device 542 may be configured to receive the one or more data packets generated according to the frame structure from transmitting communication device 502. Transmission determination component 534 of receiving communication device 542 may be configured to determine the frame structure corresponding to the received one or more data packets generated at the transmitting communication device 502 for decoding and processing.

In an aspect where communication is performed according to FDMA or OFDMA, LRLP preamble and data may be transmitted according to the aspects illustrated with respect to FIG. 3. Specifically, in the FDMA or OFDMA structure, LRLP preamble and data 304 may include an LRLP-STF 330_{N}, an LRLP-LTF1 332_{N}, an LRLP-SIG 334_{N}, a LRLP-LTF2 336_{N}, and an LRLP-Data 338_{N}. As such, the one or more data packets for transmission may be generated along multiple second portions each associated with a distinct frequency.

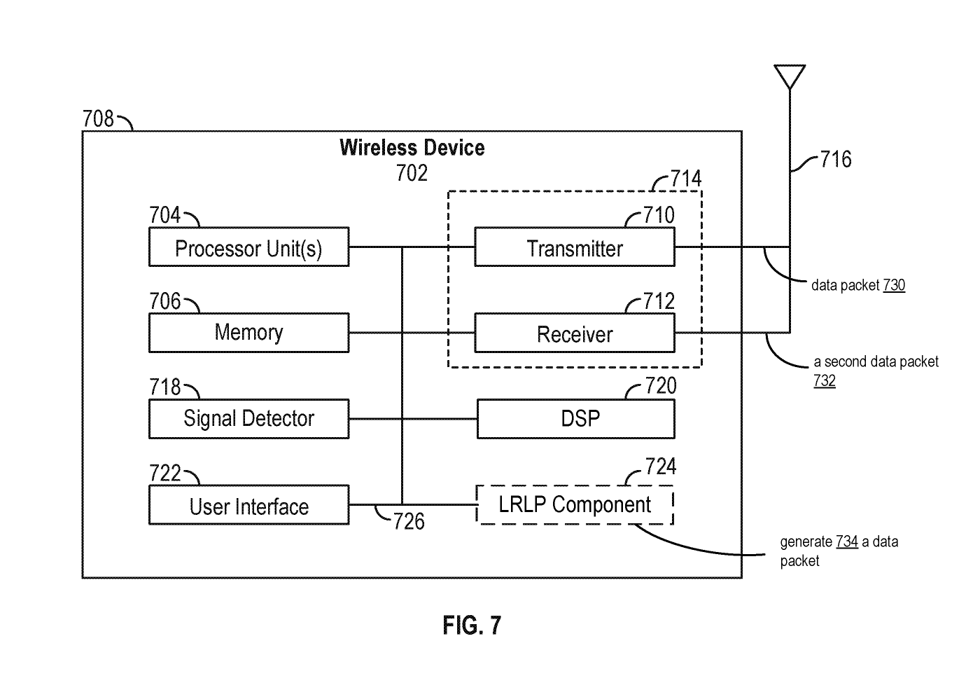

FIG. 7 shows an example functional block diagram of a wireless device 702 that performs LRLP communication within the wireless communication system 100 of FIG. 1. The wireless device 702 is an example of a device that may be configured to implement the various methods described herein. For example, the wireless device 702 may comprise an AP (e.g., the AP 105 or the STA 115).

The wireless device 702 may include a processor 704 which controls operation of the wireless device 702. The processor 704 may also be referred to as a central processing unit (CPU). Memory 706, which may include both read-only memory (ROM) and random access memory (RAM), may provide instructions and data to the processor 704. A portion of the memory 706 may also include non-volatile random access memory (NVRAM). The processor 704 typically performs logical and arithmetic operations based on program instructions stored within the memory 706. The instructions in the memory 706 may be executable (by the processor 704, for example) to implement the methods described herein.

The processor 704 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 702 may also include a housing 708, and the wireless device 702 may include a transmitter 710 and/or a receiver 712 to allow transmission and reception of data between the wireless device 702 and a remote device. The transmitter 710 and the receiver 712 may be combined into a transceiver 714. An antenna 716 may be attached to the housing 708 and electrically coupled to the transceiver 714. The wireless device 702 may also include multiple transmitters, multiple receivers, multiple transceivers, and/or multiple antennas.

The wireless device 702 may also include a signal detector 718 that may be used to detect and quantify the level of signals received by the transceiver 714 or the receiver 712. The signal detector 718 may detect such signals as total energy, energy per subcarrier per symbol, power spectral density, and other signals. The wireless device 702 may also include a DSP 720 for use in processing signals. The DSP 720 may be configured to generate a packet for transmission. In some aspects, the packet may comprise a physical layer convergence procedure (PLCP) protocol data unit (PPDU).

The wireless device 702 may further comprise a user interface 722 in some aspects. The user interface 722 may comprise a keypad, a microphone, a speaker, and/or a display. The user interface 722 may include any element or component that conveys information to a user of the wireless device 702 and/or receives input from the user.

When the wireless device 702 is implemented as an AP or a STA, the wireless device may include an LRLP component 724. The LRLP component 724 may be configured to generate 734 a data packet 730 according to one of a first frame structure that may include a first portion of symbols associated with a first technology mode of a RAT and a second portion of symbols associated with a second technology mode of the RAT or a second frame structure that may include one or more symbols associated with the second technology mode of the RAT. The LRLP component 724 may be configured to transmit the generated data packet. In an aspect, the first portion of the first frame structure may include a legacy preamble and the second portion of the first frame structure may include a second technology mode preamble and data. In an aspect, the legacy preamble of the first frame structure may include an L-STF, an L-LTF, an L-SIG field, an RL-SIG field, and an HE-SIG field. In another aspect, the HE-SIG field may correspond to one of an HE-SU signal field or an HE-EXT-SU signal field. The HE-SIG field may include one bit indicating that the second portion of symbols associated with the second technology mode follows the first portion of symbols associated with the first technology mode. In another aspect, the legacy preamble of the first frame structure may include an L-STF, an L-LTF, an L-SIG field, an RL-SIG field indicating that the second portion of symbols associated with the second technology mode follows the first portion of symbols associated with the first technology mode, and a BPSK field. In another aspect, the second technology mode preamble of the second portion may include a second technology mode STF, a second technology mode first LTF, a second technology mode SIG field, and a second technology mode second LTF. In another aspect, the second technology mode first LTF may include a BSS-specific sequence. In another aspect, the LRLP component 724 may be configured to generate the data packet according to the first frame structure by generating the data packet with multiple second portions, and each second portion of the multiple second portions may be associated with a distinct or different frequency bandwidth. In another aspect, the first portion of the first frame structure may precede the second portion of the first frame structure. In another aspect, the second frame structure may include a second technology mode preamble and may correspond to an unsynchronized second technology mode greenfield single user packet structure. In this aspect, the second technology mode preamble may include a second technology mode STF, a second technology mode first LTF, a second technology mode SIG field, and a second technology mode second LTF. In an aspect, the second technology mode first LTF may include a BSS-specific sequence. In another aspect, the second frame structure may include a second technology mode preamble and may correspond to a trigger-based second technology mode packet structure. In this aspect, the second technology mode preamble may include a shortened second technology mode STF, a second technology mode first LTF that includes a BSS-specific sequence, and a second technology mode second LTF. In another aspect, the second technology mode preamble may further include a second technology mode SIG field. In another aspect, the second frame structure may include a second technology mode preamble and may correspond to a synchronization packet structure. In this aspect, the second technology mode preamble may include a shortened second technology mode STF and one of a second technology mode first LTF or a BSS-specific sequence. In another aspect, the second frame structure may include a second technology mode preamble and may correspond to a synchronized packet transmission structure. In this aspect, the second technology mode preamble may include a shortened second technology mode STF, a second technology mode first LTF that may include a BSS-specific sequence, and a second technology mode second LTF. In another aspect, the second technology mode preamble may further include a second technology mode SIG field. In another configuration, the LRLP component 724 may be configured to receive a second data packet 732 generated according to the first frame structure or the second frame structure.

The various components of the wireless device 702 may be coupled together by a bus system 726. The bus system 726 may include a data bus, for example, as well as a power bus, a control signal bus, and a status signal bus in addition to the data bus. Components of the wireless device 702 may be coupled together or accept or provide inputs to each other using some other mechanism.

Although a number of separate components are illustrated in FIG. 7, one or more of the components may be combined or commonly implemented. For example, the processor 704 may be used to implement not only the functionality described above with respect to the processor 704, but also to implement the functionality described above with respect to the signal detector 718, the DSP 720, the user interface 722, and/or the LRLP component 724. Further, each of the components illustrated in FIG. 7 may be implemented using a plurality of separate elements.

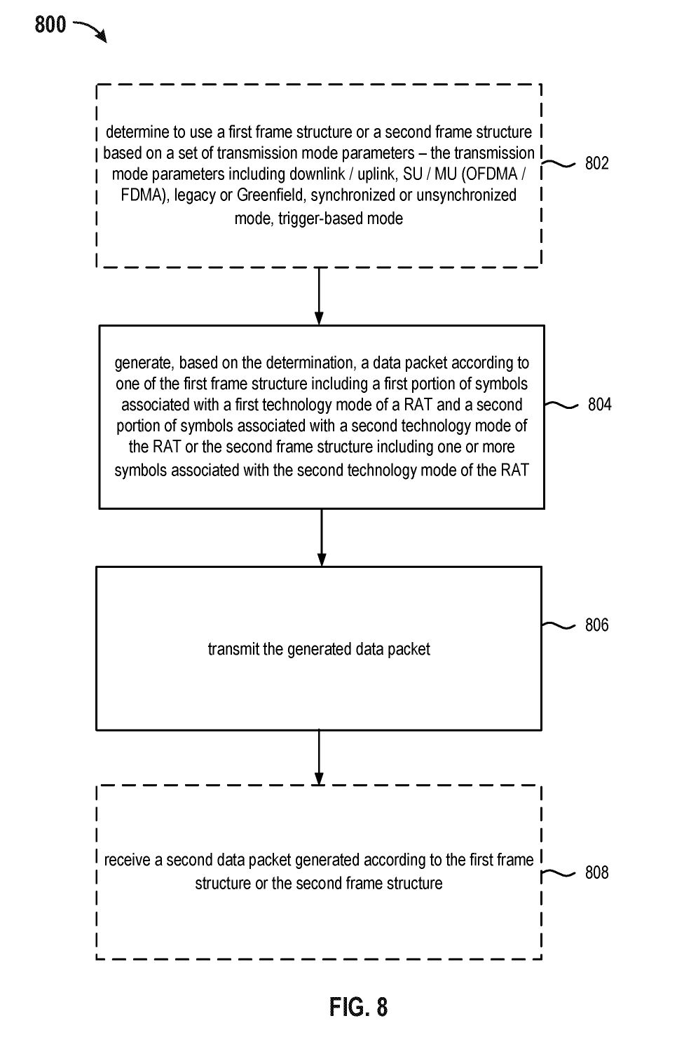

FIG. 8 is a flowchart of an example method 800 of LRLP communications. The method 800 may be performed using an apparatus (e.g., the AP 105, the AP 402, the AP 452, the STA 115, the STAs 404, 406, 408, 410, 454, 456, 458, 460, or the wireless device 702, for example). Although the method 800 is descried below with respect to the elements of the wireless device 702 of FIG. 7, other components may be used to implement one or more of the steps described herein. The dotted lines of FIG. 8 may indicate optional operations.

At block 802, the apparatus may determine to use (or select between) a first frame structure or a second frame structure based on a set of transmission mode parameters. The transmission mode parameters include whether the transmission will be downlink or uplink, SU or MU (e.g., OFDMA/FDMA), legacy or greenfield, synchronized or synchronized, trigger-based mode or untriggered-based mode. For example, referring to FIG. 4A, the apparatus may be the AP 402. The AP 402 may determine that the AP 402 has data for downlink transmission. The AP 402 may determine whether the data is to be transmitted to one or multiple to users. In this example, the AP 402 may determine that it has data for STAs 404, 406, 408. The AP 402 may determine that the STAs 404, 406, 408 are LRLP capable but the STA 410 is not LRLP capable but rather is a legacy device. Based on the foregoing determinations, the AP 402 may determine to use the first frame structure for transmission to the STAs 404, 406, 408.

At block 804, the apparatus may generate, based on the determination, a data packet according to one of the first frame structure including a first portion of symbols associated with a first technology mode of a RAT (e.g., WLAN) and a second portion of symbols associated with a second technology mode of the RAT or the second frame structure including one or more symbols associated with the second technology mode of the RAT. In one configuration, the apparatus may generate the data packet based on the first frame structure based on the determination that other legacy devices are in the vicinity. In this configuration, the apparatus may use a first variation of the first frame structure if the data packet is an SU packet and use a second variation of the first frame structure if the data packet is an MU packet. In another configuration, the apparatus may generate the data packet based on the second frame structure based on the determination that legacy devices are not in the vicinity, and all devices in the vicinity are LRLP capable. In this configuration, the apparatus may use a first variation of the second frame structure if the data packet is an SU packet and use a second variation of the second frame structure if the data packet is an MU packet. For example, referring to FIG. 4A, the AP 402 may generate the second message 414 (the data packet) according to first frame structure based on the determination that not all devices in the vicinity of the AP 402 are LRLP capable. The AP 402 may further generate the second message 414 by selecting the second variation 250 of the first frame structure because the second message 414 is intended for an MU transmission. Had the second message 414 been intended for an SU transmission, the AP 402 may have selected the first variation 200 of the first frame structure.

At block 806, the apparatus may transmit the generated data packet. For example, referring to FIG. 4A, the AP 402 may transmit the second message 414.

At block 808, the apparatus may receive a second data packet generated according to the first frame structure or the second frame structure. For example, referring to FIG. 4B, the AP 452 may receive the sixth message 462 (the second data packet) generated according to the first frame structure.

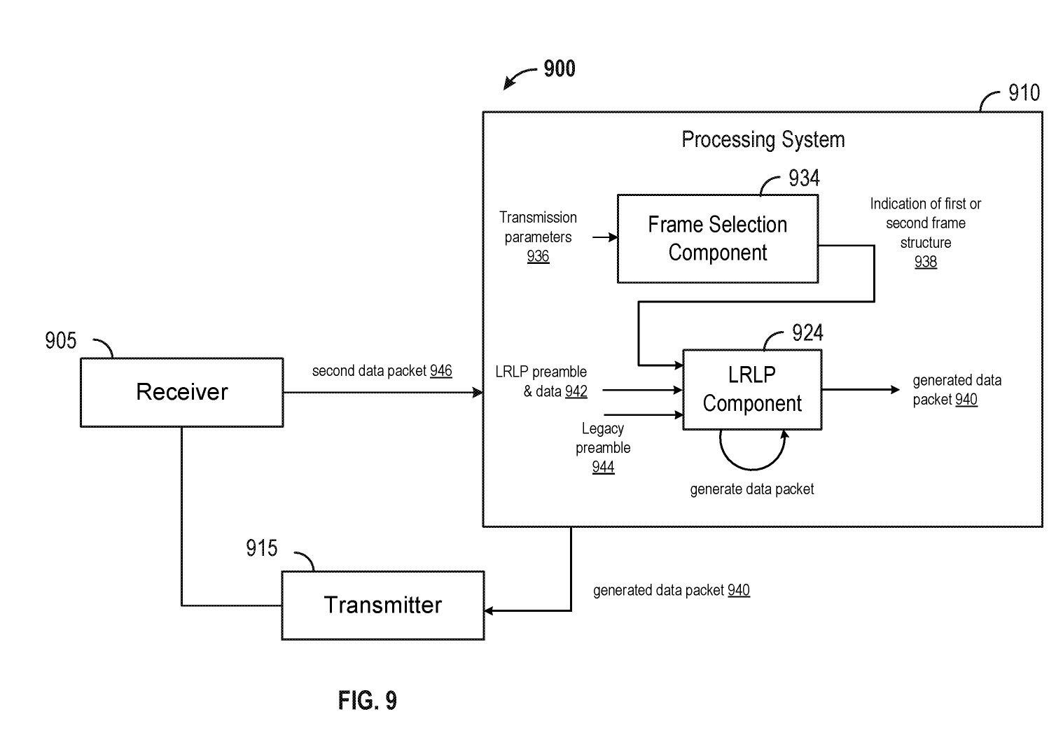

FIG. 9 is a functional block diagram of an example wireless communication device 900 that may perform LRLP communications. The wireless communication device 900 may include a receiver 905, a processing system 910, and a transmitter 915. The processing system 910 may include an LRLP component 924 and/or a frame selection component 934. The processing system 910 and/or frame selection component 934 may be configured to determine to use a first frame structure or a second frame structure based on a set of transmission mode parameters 936. In an aspect, the frame selection component 934 may provide an indication of the first or second frame structure 938 to the LRLP component 924. The processing system 910 and/or the LRLP component 924 may be configured to generate a data packet 940 according to one of a first frame structure that may include a first portion of symbols associated with a first technology mode of a RAT and a second portion of symbols associated with a second technology mode of the RAT or a second frame structure that may include one or more symbols associated with the second technology mode of the RAT. The data packet 940 may be based on LRLP preamble and data information 942 and/or legacy preamble information 944. The transmitter 915, the processing system 910, and/or the LRLP component 924 may be configured to transmit the generated data packet. In an aspect, the first portion of the first frame structure may include a legacy preamble and the second portion of the first frame structure may include a second technology mode preamble and data. In an aspect, the legacy preamble of the first frame structure may include an L-STF, an L-LTF, an L-SIG field, an RL-SIG field, and an HE-SIG field. In another aspect, the HE-SIG field may correspond to one of an HE-SU signal field or an HE-EXT-SU signal field. The HE-SIG field may include one bit indicating that the second portion of symbols associated with the second technology mode follows the first portion of symbols associated with the first technology mode. In another aspect, the legacy preamble of the first frame structure may include an L-STF, an L-LTF, an L-SIG field, an RL-SIG field indicating that the second portion of symbols associated with the second technology mode follows the first portion of symbols associated with the first technology mode, and a BPSK field. In another aspect, the second technology mode preamble of the second portion may include a second technology mode STF, a second technology mode first LTF, a second technology mode SIG field, and a second technology mode second LTF. In another aspect, the second technology mode first LTF may include a BSS-specific sequence. In another aspect, the LRLP component 724 may be configured to generate the data packet according to the first frame structure by generating the data packet with multiple second portions, and each second portion of the multiple second portions may be associated with a distinct or different frequency bandwidth. In another aspect, the first portion of the first frame structure may precede the second portion of the first frame structure. In another aspect, the second frame structure may include a second technology mode preamble and may correspond to an unsynchronized second technology mode greenfield single user packet structure. In this aspect, the second technology mode preamble may include a second technology mode STF, a second technology mode first LTF, a second technology mode SIG field, and a second technology mode second LTF. In an aspect, the second technology mode first LTF may include a BSS-specific sequence. In another aspect, the second frame structure may include a second technology mode preamble and may correspond to a trigger-based second technology mode packet structure. In this aspect, the second technology mode preamble may include a shortened second technology mode STF, a second technology mode first LTF that includes a BSS-specific sequence, and a second technology mode second LTF. In another aspect, the second technology mode preamble may further include a second technology mode SIG field. In another aspect, the second frame structure may include a second technology mode preamble and may correspond to a synchronization packet structure. In this aspect, the second technology mode preamble may include a shortened second technology mode STF and one of a second technology mode first LTF or a BSS-specific sequence. In another aspect, the second frame structure may include a second technology mode preamble and may correspond to a synchronized packet transmission structure. In this aspect, the second technology mode preamble may include a shortened second technology mode STF, a second technology mode first LTF that may include a BSS-specific sequence, and a second technology mode second LTF. In another aspect, the second technology mode preamble may further include a second technology mode SIG field. In another configuration, the receiver 905, the processing system 910, and/or the LRLP component 924 may be configured to receive a second data packet 946 generated according to the first frame structure or the second frame structure.

The receiver 905, the processing system 910, the LRLP component 924, the frame selection component 934, and/or the transmitter 915 may be configured to perform one or more functions discussed above with respect to blocks 802, 804, 806, 808 of FIG. 8. The receiver 905 may correspond to the receiver 712. The processing system 910 may correspond to the processor 704. The transmitter 915 may correspond to the transmitter 710. The LRLP component 924 may correspond to the LRLP component 124 and/or the LRLP component 724.

In one configuration, the wireless communication device 900 may include means for determining to use a first frame structure or a second frame structure based on a set of transmission mode parameters. The wireless communication device 900 may include means for generating a data packet according to one of a first frame structure that may include a first portion of symbols associated with a first technology mode of a RAT and a second portion of symbols associated with a second technology mode of the RAT or a second frame structure that may include one or more symbols associated with the second technology mode of the RAT. The wireless communication device 900 may include means for transmitting the generated data packet. In an aspect, the first portion of the first frame structure may include a legacy preamble and the second portion of the first frame structure may include a second technology mode preamble and data. In an aspect, the legacy preamble of the first frame structure may include an L-STF, an L-LTF, an L-SIG field, an RL-SIG field, and an HE-SIG field. In another aspect, the HE-SIG field may correspond to one of an HE-SU signal field or an HE-EXT-SU signal field. The HE-SIG field may include one bit indicating that the second portion of symbols associated with the second technology mode follows the first portion of symbols associated with the first technology mode. In another aspect, the legacy preamble of the first frame structure may include an L-STF, an L-LTF, an L-SIG field, an RL-SIG field indicating that the second portion of symbols associated with the second technology mode follows the first portion of symbols associated with the first technology mode, and a BPSK field. In another aspect, the second technology mode preamble of the second portion may include a second technology mode STF, a second technology mode first LTF, a second technology mode SIG field, and a second technology mode second LTF. In another aspect, the second technology mode first LTF may include a BSS-specific sequence. In another aspect, the LRLP component 724 may be configured to generate the data packet according to the first frame structure by generating the data packet with multiple second portions, and each second portion of the multiple second portions may be associated with a distinct or different frequency bandwidth. In another aspect, the first portion of the first frame structure may precede the second portion of the first frame structure. In another aspect, the second frame structure may include a second technology mode preamble and may correspond to an unsynchronized second technology mode greenfield single user packet structure. In this aspect, the second technology mode preamble may include a second technology mode STF, a second technology mode first LTF, a second technology mode SIG field, and a second technology mode second LTF. In an aspect, the second technology mode first LTF may include a BSS-specific sequence. In another aspect, the second frame structure may include a second technology mode preamble and may correspond to a trigger-based second technology mode packet structure. In this aspect, the second technology mode preamble may include a shortened second technology mode STF, a second technology mode first LTF that includes a BSS-specific sequence, and a second technology mode second LTF. In another aspect, the second technology mode preamble may further include a second technology mode SIG field. In another aspect, the second frame structure may include a second technology mode preamble and may correspond to a synchronization packet structure. In this aspect, the second technology mode preamble may include a shortened second technology mode STF and one of a second technology mode first LTF or a BSS-specific sequence. In another aspect, the second frame structure may include a second technology mode preamble and may correspond to a synchronized packet transmission structure. In this aspect, the second technology mode preamble may include a shortened second technology mode STF, a second technology mode first LTF that may include a BSS-specific sequence, and a second technology mode second LTF. In another aspect, the second technology mode preamble may further include a second technology mode SIG field. In another configuration, the wireless communication device 900 may include means for receiving a second data packet generated according to the first frame structure or the second frame structure.

For example, means for determining to use a first frame structure or a second frame structure may include the processing system 910, the LRLP component 924, and/or the frame selection component 934. Means for generating, based on the determination, a data packet may include the processing system 910, the LRLP component 924, and/or the frame selection component 934. Means for transmitting the generated data packet may include the transmitter 915, the processing system 910, and/or the LRLP component 924. Means for receiving a second data packet may include the receiver 905, the processing system 910, and/or the LRLP component 924.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. An apparatus for wireless communication, comprising:
a memory; and
at least one processor coupled to the memory and configured to:
generate a data packet according to one of a first frame structure comprising a first portion of symbols associated with a first technology mode of a radio access technology (RAT) and a second portion of symbols associated with a second technology mode of the RAT or a second frame structure comprising one or more symbols associated with the second technology mode of the RAT; and
transmit the generated data packet.

2. The apparatus of claim 1, wherein the first portion of the first frame structure comprises a legacy preamble and the second portion of the first frame structure comprises a second technology mode preamble and data, wherein the apparatus operates in the first technology mode for data packet generation when at least one wireless device within a distance threshold of the apparatus is not LRLP capable, and wherein the apparatus operates in the second technology mode for data packet generation when all wireless devices within the distance threshold of the apparatus are LRLP capable.

3. The apparatus of claim 2, wherein the legacy preamble of the first frame structure comprises:
a legacy short training field (L-STF),
a legacy long training field (L-LTF),
a legacy signal (L-SIG) field,
a repeated legacy signal (RL-SIG) field, and
a high efficiency signal (HE-SIG) field.

4. The apparatus of claim 3, wherein the HE-SIG field corresponds to one of a high efficiency single user (HE-SU) signal field or a high efficiency extended mode single user (HE-EXT-SU) signal field, and wherein the HE-SIG field comprises one bit indicating that the second portion of symbols associated with the second technology mode follows the first portion of symbols associated with the first technology mode.

5. The apparatus of claim 2, wherein the legacy preamble of the first frame structure comprises:
a legacy short training field (L-STF),
a legacy long training field (L-LTF),
a legacy signal (L-SIG) field,
a repeated legacy signal (RL-SIG) field indicating that the second portion of symbols associated with the second technology mode follows the first portion of symbols associated with the first technology mode, and
a Binary Phase Shift Keying (BPSK) field.

6. The apparatus of claim 2, wherein the second technology mode preamble of the second portion includes:
a second technology mode short training field (STF),
a second technology mode first long training field (LTF),
a second technology mode signal (SIG) field, and
a second technology mode second LTF.

7. The apparatus of claim 6, wherein the second technology mode first LTF comprises a basic service set (BSS)-specific sequence.

8. The apparatus of claim 2, wherein the at least one processor is configured to generate the data packet according to the first frame structure by generating the data packet with multiple second portions, and wherein each second portion of the multiple second portions is associated with a distinct frequency bandwidth.

9. The apparatus of claim 2, wherein the first portion of the first frame structure precedes the second portion of the first frame structure.

10. The apparatus of claim 1, wherein the second frame structure comprises a second technology mode preamble and corresponds to an unsynchronized second technology mode greenfield single user packet structure, the second technology mode preamble comprising:
a second technology mode short training field (STF),
a second technology mode first long training field (LTF),
a second technology mode signal (SIG) field, and
a second technology mode second LTF.

11. The apparatus of claim 10, wherein the second technology mode first LTF comprises a basic service set (BSS)-specific sequence.

12. The apparatus of claim 1, wherein the second frame structure comprises a second technology mode preamble and corresponds to a trigger-based second technology mode packet structure, the second technology mode preamble comprising:
a shortened second technology mode short training field (STF),
a second technology mode first long training field (LTF) comprising a basic service set (BSS)-specific sequence, and
a second technology mode second LTF.

13. The apparatus of claim 12, wherein the second technology mode preamble further comprises a second technology mode signal (SIG) field.

14. The apparatus of claim 1, wherein the second frame structure comprises a second technology mode preamble and corresponds to a synchronization packet structure, the second technology mode preamble comprising:
a shortened second technology mode short training field (STF), and
one of a second technology mode first long training field (LTF) or a basic service set (BSS)-specific sequence.

15. The apparatus of claim 1, wherein the second frame structure comprises a second technology mode preamble and corresponds to a synchronized packet transmission structure, the second technology mode preamble comprising:
a shortened second technology mode short training field (STF),
a second technology mode first long training field (LTF) comprising a basic service set (BSS)-specific sequence, and
a second technology mode second LTF.

16. The apparatus of claim 15, wherein the second technology mode preamble further comprises a second technology mode signal (SIG) field.

17. The apparatus of claim 1, wherein the at least one processor is further configured to receive a second data packet generated according to the first frame structure or the second frame structure.

18. A method of wireless communication, comprising:
generating a data packet according to one of a first frame structure comprising a first portion of symbols associated with a first technology mode of a radio access technology (RAT) and a second portion of symbols associated with a second technology mode of the RAT or a second frame structure comprising one or more symbols associated with the second technology mode of the RAT; and
transmitting the generated data packet.

19. The method of claim 18, wherein the first portion of the first frame structure comprises a legacy preamble and the second portion of the first frame structure comprises a second technology mode preamble and data.

20. The method of claim 19, wherein the legacy preamble of the first frame structure comprises:
a legacy short training field (L-STF),
a legacy long training field (L-LTF),
a legacy signal (L-SIG) field,
a repeated legacy signal (RL-SIG) field, and
a high efficiency signal (HE-SIG) field.

21. The method of claim 20, wherein the HE-SIG field corresponds to one of a high efficiency single user (HE-SU) signal field or a high efficiency extended mode single user (HE-EXT-SU) signal field, and wherein the HE-SIG field comprises one bit indicating that the second portion of symbols associated with the second technology mode follows the first portion of symbols associated with the first technology mode.

22. The method of claim 19, wherein the legacy preamble of the first frame structure comprises:
a legacy short training field (L-STF),
a legacy long training field (L-LTF),
a legacy signal (L-SIG) field,
a repeated legacy signal (RL-SIG) field indicating that the second portion of symbols associated with the second technology mode follows the first portion of symbols associated with the first technology mode, and
a Binary Phase Shift Keying (BPSK) field.

23. The method of claim 19, wherein the second technology mode preamble of the second portion includes:
a second technology mode short training field (STF),
a second technology mode first long training field (LTF),
a second technology mode signal (SIG) field, and
a second technology mode second LTF, wherein the second technology mode first LTF comprises a basic service set (BSS)-specific sequence.

24. The method of claim 19, wherein the generating the data packet according to the first frame structure comprises generating the data packet with multiple second portions, and wherein each second portion of the multiple second portions is associated with a distinct frequency bandwidth.

25. The method of claim 18, wherein the second frame structure comprises a second technology mode preamble and corresponds to an unsynchronized second technology mode greenfield single user packet structure, the second technology mode preamble comprising:
a second technology mode short training field (STF),
a second technology mode first long training field (LTF),
a second technology mode signal (SIG) field, and
a second technology mode second LTF, wherein the second technology mode first LTF comprises a basic service set (BSS)-specific sequence.

26. The method of claim 18, wherein the second frame structure comprises a second technology mode preamble and corresponds to a trigger-based second technology mode packet structure, the second technology mode preamble comprising:
a shortened second technology mode short training field (STF),
a second technology mode first long training field (LTF) comprising a basic service set (BSS)-specific sequence,
a second technology mode signal (SIG) field, and
a second technology mode second LTF.

27. The method of claim 18, wherein the second frame structure comprises a second technology mode preamble and corresponds to a synchronization packet structure, the second technology mode preamble comprising:
a shortened second technology mode short training field (STF), and
one of a second technology mode first long training field (LTF) or a basic service set (BSS)-specific sequence.

28. The method of claim 18, wherein the second frame structure comprises a second technology mode preamble and corresponds to a synchronized packet transmission structure, the second technology mode preamble comprising:
a shortened second technology mode short training field (STF),
a second technology mode first long training field (LTF) comprising a basic service set (BSS)-specific sequence,
a second technology mode signal (SIG) field, and
a second technology mode second LTF.

29. An apparatus for wireless communication, comprising:
means for generating a data packet according to one of a first frame structure comprising a first portion of symbols associated with a first technology mode of a radio access technology (RAT) and a second portion of symbols associated with a second technology mode of the RAT or a second frame structure comprising one or more symbols associated with the second technology mode of the RAT; and
means for transmitting the generated data packet.

30. A computer-readable medium storing computer executable code, comprising code to:
generate a data packet according to one of a first frame structure comprising a first portion of symbols associated with a first technology mode of a radio access technology (RAT) and a second portion of symbols associated with a second technology mode of the RAT or a second frame structure comprising one or more symbols associated with the second technology mode of the RAT; and
transmit the generated data packet.
